(19) United States
(12) Patent Application Publication
(10) Pub. No.: US 2025/0377841 A1
(43) Pub. Date: Dec. 11, 2025

(54) IMAGE FORMING APPARATUS, METHOD FOR CONTROLLING SAME, AND STORAGE MEDIUM

(71) Applicant: CANON KABUSHIKI KAISHA, Tokyo (JP)

(72) Inventor: TAKANOBU SUZUKI, Kanagawa (JP)

(21) Appl. No.: 19/213,153

(22) Filed: May 20, 2025

(30) Foreign Application Priority Data
Jun. 7, 2024 (JP) 2024-093202

(51) Int. Cl. G06F 3/12

(52) U.S. Cl. CPC G06F 3/1231; G06F 3/1205; G06F 3/1257; G06F 3/1288

(57) ABSTRACT

The image forming apparatus comprising: one or more memory devices that store a set of instructions; and one or more processors that execute the set of instructions to: store data relating to a print image printed during use of a subscription service relating to the image forming apparatus; determine whether or not input for stopping the use of the subscription service has been accepted; and output an image based on at least part of the data upon determining that the input has been accepted.

### BACKGROUND OF THE INVENTION

### Field of the Invention

The present invention relates to an image forming apparatus, a method for controlling the image forming apparatus, and a storage medium.

### Description of the Related Art

A consumables subscription service in which a consumable to be used for printing in an image forming apparatus can be used at a flat rate, and a device-inclusive subscription service in which the image forming apparatus itself is also made available are conventionally known. Furthermore, a technique has been proposed in which, at the time of unsubscription from a subscription service, a user is notified of another optimal pricing plan in accordance with the user's form of use to prevent the user from unsubscribing (Japanese Patent Laid-Open No. 2021-68391).

For example, in a case in which a user who has ceased to use a service (or temporarily stopped using the service) is a heavy user who has been using the service for many years, even if another pricing plan is provided to the heavy user, the chances are that the heavy user already knows the plan. As such, the provision of information that is already known is unlikely to have the effect of improving customer satisfaction. The same also applies to a user switching between plans, a user considering replacing an image forming apparatus with another, etc.

### SUMMARY OF THE INVENTION

The present invention enables realization of a novel mechanism for improving customer satisfaction of a user using a subscription service relating to an image forming apparatus.

One aspect of the present invention provides an image forming apparatus included in an image forming system, the image forming apparatus comprising: one or more memory devices that store a set of instructions; and one or more processors that execute the set of instructions to: store data relating to a print image printed during use of a subscription service relating to the image forming apparatus; determine whether or not input for stopping the use of the subscription service has been accepted; and output an image based on at least part of the data upon determining that the input has been accepted.

Further features of the present invention will be apparent from the following description of exemplary embodiments with reference to the attached drawings.

### BRIEF DESCRIPTION OF THE DRAWINGS

FIG. 1 is a diagram illustrating a network configuration according to one embodiment.

FIG. 2 is a diagram illustrating an appearance of an image forming apparatus according to one embodiment.

FIG. 3 is an internal configuration diagram of the image forming apparatus according to one embodiment.

FIG. 4 is a block diagram of the image forming apparatus according to one embodiment.

FIG. 5 is a block diagram of a management server according to one embodiment.

FIG. 6 is a block diagram of a host terminal according to one embodiment.

FIG. 7 is a sequence diagram of an image forming system according to one embodiment.

FIG. 8 is a flowchart illustrating a procedure of processing by the image forming apparatus according to one embodiment.

FIG. 9 is a flowchart illustrating a procedure of processing by the image forming apparatus according to one embodiment.

FIG. 10 is a flowchart illustrating a procedure of processing by the image forming apparatus according to one embodiment.

FIG. 11 is a diagram illustrating a display screen according to one embodiment.

FIG. 12 is a diagram illustrating a display screen according to one embodiment.

FIG. 13 is a diagram illustrating a display screen according to one embodiment.

FIG. 14 is a diagram illustrating a character table according to one embodiment.

FIG. 15 is a diagram illustrating a setting screen according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the present description, the term “image forming apparatus” covers a wide range of apparatuses that form (record) images on recording materials (recording media), such as single-function printers, copiers, multi-function printers, and commercial printers. Furthermore, the image forming apparatus may be a system (image forming system) obtained by connecting an image-forming-apparatus main body that forms images on recording materials and devices such as a sheet processing device and a sheet feeding device.

### Network Configuration

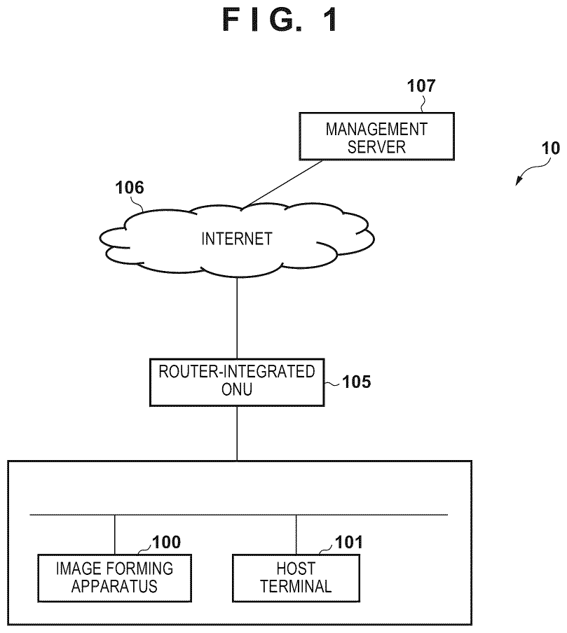

First, with reference to FIG. 1, an example of a network configuration according to the present embodiment will be described. An image forming system 10 according to the present embodiment includes an image forming apparatus 100, a host terminal 101, and a management server 107.

Specifically, the image forming apparatus 100 performs printing operations in which consumables are used. The image forming apparatus 100 is communicably connected to the host terminal 101, and is also communicably connected to the Internet 106 and the management server 107 via a router-integrated optical network unit (ONU) 105. Note that the printing method in the image forming apparatus 100 may be the electrophotographic method, the inkjet method, or the screen-printing method, or may be another method. Furthermore, the ONU 105 is a fiber-optic terminal device, and has the function of mutually converting a fiber-optic optical signal and an electrical digital signal to and from one another. The router-integrated ONU 105 according to the present embodiment is connected to the Internet 106 via a fiber-optic line.

The host terminal 101 is communicably connected to the image forming apparatus 100, and is communicably connected to the Internet 106 and the management server 107 via the router-integrated ONU 105. For example, the host terminal herein is a smartphone or a personal computer. A user carries out a procedure for subscribing to a subscription service using the host terminal 101.

The management server 107 is connected to the Internet 106. The management server 107 holds information relating to users who have subscribed to the subscription service, identification information (e.g., serial numbers or the like) of image forming apparatuses 100 being used in the subscription service, and print logs collected from print history logs transmitted from the image forming apparatuses 100.

### Image Forming Apparatus 100

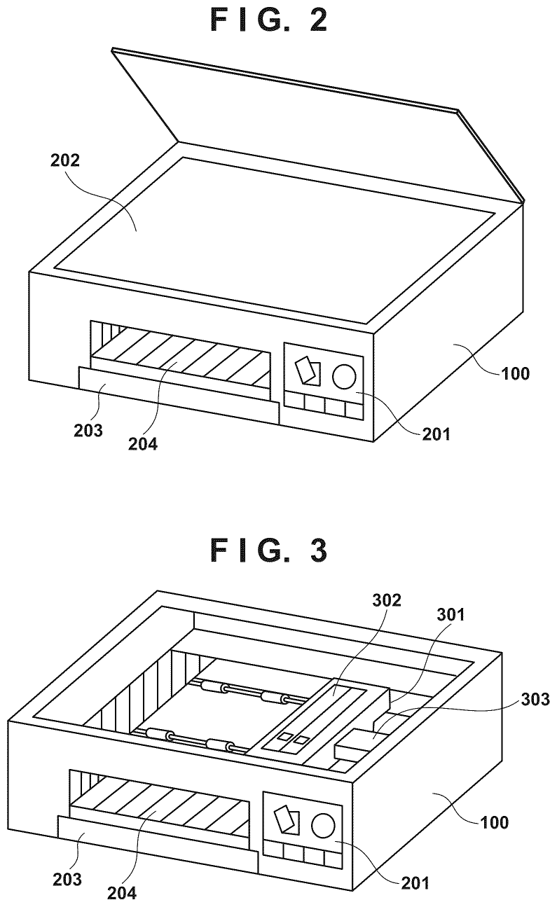

Next, the apparatuses constituting the image forming system 10 will be described in detail. As illustrated in FIG. 2, the image forming apparatus 100 includes a touch panel 201. The user can control the image forming apparatus 100 by operating the touch panel 201. Note that it can be expected that, as operations on a screen displayed on the touch panel 201, operations involving contact with the displayed screen (touch operations, slide operations, drag operations, swipe operations, etc.), operations of pressing unillustrated press-type buttons, etc., will be performed. Furthermore, the touch panel is merely an example, and there is no limitation in size, type, etc., as long as the image forming apparatus 100 can be controlled. For example, the screen may be output to an external apparatus and be operated by a pointing device connected to the external apparatus.

Furthermore, the image forming apparatus 100 includes a platen 202 on which documents to be copied, scanned, etc., are placed, a paper feed port 203 from which printing paper is supplied, and a print-result eject port 204 from which printed paper is ejected. Furthermore, as illustrated in FIG. 3, the image forming apparatus 100 includes therein a carriage 301, ink tanks 302, and a packing material 303.

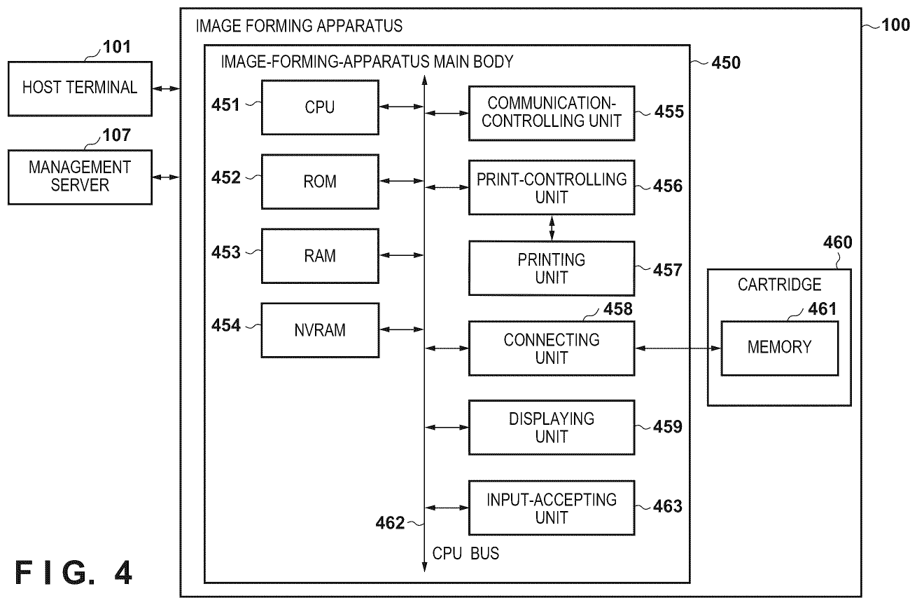

Next, functional blocks of the image forming apparatus 100 will be described with reference to FIG. 4. The image forming apparatus 100 includes an image-forming-apparatus main body 450 that performs printing operations using recording materials, and a cartridge 460 that can be attached to the image-forming-apparatus main body 450 and that is filled with ink used as a recording material.

The image-forming-apparatus main body 450 includes a CPU 451, a ROM 452, a RAM 453, an NVRAM 454, a communication-controlling unit 455, a print-controlling unit 456, a printing unit 457, a connecting unit 458, a displaying unit 459, and an input-accepting unit 463. These components are connected to one another via a CPU bus 462 managed by the CPU 451.

The CPU 451 is a system controller, and controls the entire image forming apparatus 100. Control execution codes (programs) for the image forming apparatus 100 are stored in the ROM 452. Print image data is temporarily stored in the RAM 453 during execution of control of the image forming apparatus 100. The NVRAM 454 is a non-volatile memory, and contract information that is necessary for the maintenance of the image forming apparatus 100, logs of various types of data, and image-related information for printing are stored in the NVRAM 454.

The communication-controlling unit 455 (example of “communicating unit”) is configured to include a communication module, and controls the exchange of data with the outside via various interfaces for the Internet 106, Bluetooth (registered trademark), etc. The print-controlling unit 456 controls print processing performed by the printing unit 457. The printing unit 457 includes components such as those illustrated in FIGS. 2 and 3, and performs print processing by accepting print commands issued by the print-controlling unit 456. Note that a print history log is a log obtained by compiling a job mode such as copying or printing, print volume, and a print result. The print-controlling unit 456 generates a print history log for each job involving a printing operation. Furthermore, the print-controlling unit 456 transmits the print history log to the management server 107 via the communication-controlling unit 455.

The displaying unit 459 is configured to include the touch panel 201, and displays information on the touch panel 201. Furthermore, the input-accepting unit 463 is configured to include the touch panel 201, and accepts the input of information via the touch panel 201.

The cartridge 460 includes a memory 461. The memory 461 has recorded therein cartridge identification information 1 for identifying the cartridge 460, and cartridge remaining amount information 2 indicating information about the remaining amount of ink. The cartridge identification information 1 is a serial number assigned when the cartridge is manufactured. The cartridge remaining amount information 2 is information relating to the remaining amount of ink included in the cartridge, and may be expressed in units of volume or in remaining-amount levels divided by one or more predetermined thresholds.

The cartridge 460 may be any cartridge that can be filled with a recording material used for printing and can be removed from the connecting unit 458 and replaced. Thus, the cartridge 460 is not limited only to an ink cartridge, and may be a toner cartridge, for example.

### Management Server 107

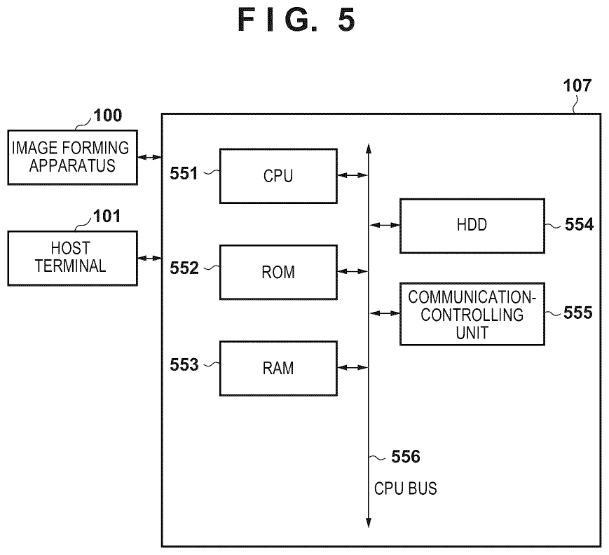

Next, functional blocks of the management server 107 will be described with reference to FIG. 5. The management server 107 includes a CPU 551, a ROM 552, a RAM 553, an HDD 554, and a communication-controlling unit 555.

The CPU 551 is a system controller, and controls the entire management server 107. Control execution codes (programs), an embedded operating system (OS) program, etc., for the management server 107 are stored in the ROM 552. Various types of data used temporarily during the execution of control of the management server 107 are stored in the RAM 553. The HDD 554 is a non-volatile memory. Various types of data that are necessary for the maintenance of the management server 107, and information relating to users who have subscribed to the subscription service are stored in the HDD 554. Furthermore, identification information (e.g., serial numbers or the like) of image forming apparatuses 100 being used in the subscription service, and print history logs transmitted from the image forming apparatuses 100 are stored in the HDD 554.

The communication-controlling unit 555 is configured to include a communication module, and controls the exchange of data with the outside of the management server 107 via various interfaces for the Internet 106, Bluetooth (registered trademark), etc. These components are connected to one another via a CPU bus 556 managed by the CPU 551.

### Host Terminal 101

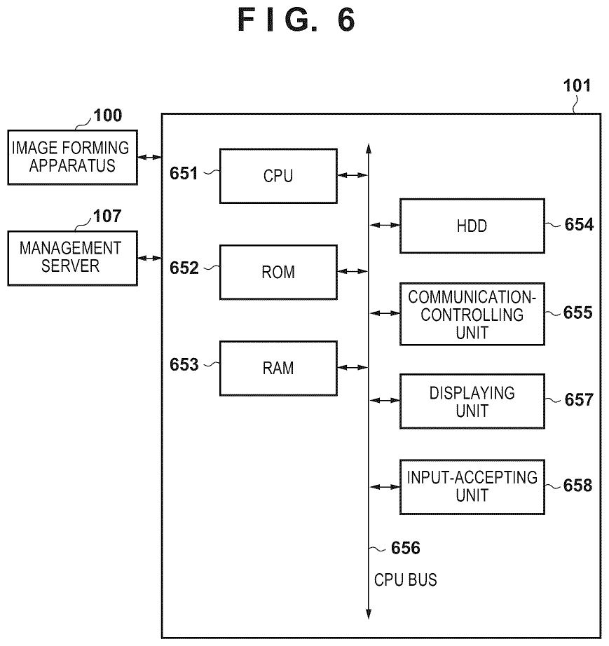

Next, functional blocks of the host terminal 101 will be described with reference to FIG. 6. The host terminal 101 includes a CPU 651, a ROM 652, a RAM 653, an HDD 654, a communication-controlling unit 655, a displaying unit 657, and an input-accepting unit 658. These components are connected to one another via a CPU bus 656 managed by the CPU 651.

The CPU 651 is a system controller, and controls the host terminal 101. Control execution codes (programs) for the host terminal 101 are stored in the ROM 652. Various types of data used temporarily during the execution of control of the host terminal 101 are stored in the RAM 653. The HDD 654 is a non-volatile memory, and various types of data that are necessary for the maintenance of the host terminal 101 are stored therein. The communication-controlling unit 655 is configured to include a communication module, and controls the exchange of data with the outside of the host terminal 101 via various interfaces for the Internet 106, Bluetooth (registered trademark), etc,

For example, the host terminal 101 includes a touch-panel display. Furthermore, the displaying unit 657 is configured to include the touch panel display, and displays information on the touch-panel display. Furthermore, the input-accepting unit 658 is configured to include the touch-panel display, and accepts the input of information via the touch-panel display.

Thus, the host terminal 101 can connect to the network via the Internet 106 and communicate with the management server 107. Due to this, for example, the user can carry out a procedure for subscribing to the subscription service by operating the host terminal 101. Specifically, the input-accepting unit 658 accepts input for the subscription procedure from the user. Then, the CPU 651 launches a browser or the like stored in the ROM 652. Furthermore, the CPU 651 connects to the management server 107 via the communication-controlling unit 655, and transmits information relating to the subscription procedure accepted from the user. Also, the CPU 651 can acquire data from the management server 107 via the communication-controlling unit 655. Furthermore, by using the acquired data, the displaying unit 657 displays information relating to the subscription procedure on the touch-panel display.

Similarly, the host terminal 101 can also communicate with the image forming apparatus 100. For example, by operating the host terminal 101, the user can transmit a print job to the image forming apparatus 100. Specifically, the input-accepting unit 658 accepts input of a print job from the user. Then, the CPU 651 launches a dedicated application or printer driver for the image forming apparatus 100 that is stored in the ROM 652. Furthermore, the CPU 651 transmits the print job to the image forming apparatus 100 via the communication-controlling unit 655.

### Processing Flow in Image Forming System 10

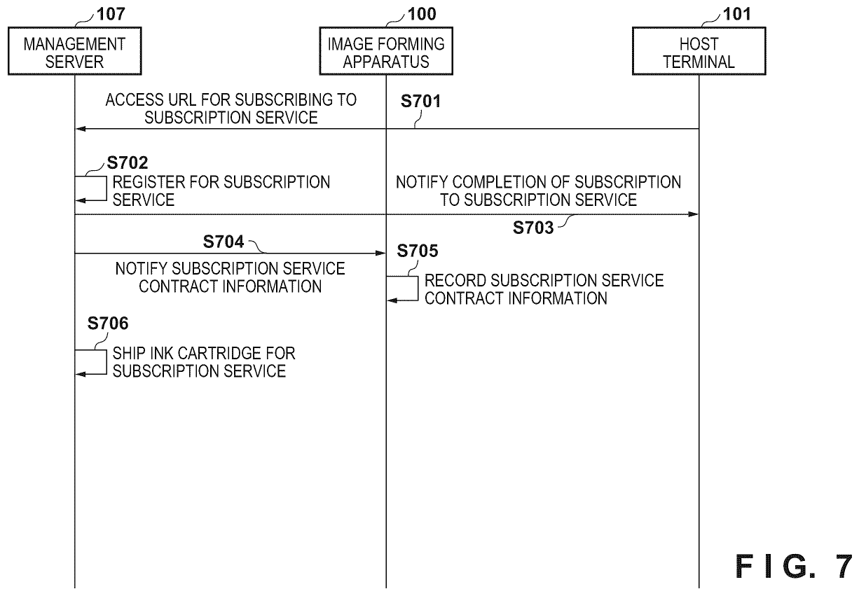

With reference to FIG. 7, the process until the user enters into a contract for using the subscription service will be described. For example, the following process is realized by the CPU 451, the CPU 551, and the CPU 651 respectively loading programs stored in the ROM 452, the ROM 552, and the ROM 652 into the RAM 453, the RAM 553, and the RAM 653 to execute the programs.

In step S701, the host terminal 101 accepts a user operation and accesses a subscription URL of the management server 107 from a browser or the like. In step S702, the host terminal 101 accepts user input of information that is necessary to subscribe to the subscription service, e.g., the subscriber's name, a consumable shipping address, and a payment method. The host terminal 101 communicates the accepted user input to the management server 107. Then, in the management server 107, the CPU 551 stores, in the HDD 554, the information relating to the user, who has subscribed to the subscription service.

In step S703, the CPU 551 of the management server 107 transmits, to the host terminal 101 via the communication-controlling unit 555, information relating to a notification of completion of subscription to the subscription service. In the host terminal 101, the CPU 651 receives this information via the communication-controlling unit 655. Then, the displaying unit 657 displays this information on the touch-panel display. In step S704, upon conclusion of the contract, the CPU 551 of the management server 107 transmits subscription service contract information to the image forming apparatus 100 via the communication-controlling unit 555.

In step S705, the CPU 451 of the image forming apparatus 100 receives the subscription service contract information via the communication-controlling unit 455. Then, the CPU 451 stores this information in the NVRAM 454. At this time, the user state regarding subscription to the subscription service is either a completion-of-subscription waiting state for a device-inclusive subscription service or a completion-of-subscription waiting state for a consumables subscription service, for example.

In step S706, the CPU 551 of the management server 107 performs a procedure for arranging shipment, to the subscriber, of a dedicated consumable (dedicated cartridge) for the subscription service. Then, the dedicated consumable (dedicated cartridge) for the subscription service shipped by the service provider is delivered to the user.

If the user attaches this dedicated consumable to the cartridge 460 of the image forming apparatus 100, the connecting unit 458 of the image forming apparatus 100 updates the subscription service contract information in the NVRAM 454. Specifically, in the subscription service contract information stored in the NVRAM 454, the connecting unit 458 updates the completion-of-subscription waiting state of the device-inclusive subscription service to a subscribed state of the device-inclusive subscription service, for example. Alternatively, the connecting unit 458 updates the completion-of-subscription waiting state of the consumables subscription service to a subscribed state of the consumables subscription service, for example. Through such a processing flow, the provision of various services in the subscription service is started.

Note that the flow of processing in a case in which the user unsubscribes from the subscription service (example of “stopping the use of a subscription service relating to an image forming apparatus”) would also be similar to that in step S701 to step S705. Specifically, in step S701, the user accesses the management server 107 from the host terminal 101. Furthermore, in step S702, the CPU 551 of the management server 107 registers information indicating unsubscription of the user to the HDD 554. Furthermore, in step S703, the CPU 551 of the management server 107 communicates a subscription service unsubscription completion notification to the host terminal 101. Furthermore, in step S704, the CPU 551 of the management server 107 transmits subscription service unsubscription information to the image forming apparatus 100. Then, in step S705, the CPU 451 of the image forming apparatus 100 receives the subscription service unsubscription information from the management server 107 via the communication-controlling unit 455. Then, the CPU 451 updates the subscription service contract information stored in the NVRAM 454 to an unsubscribed state. Note that similar processing is also executed in a case in which the user temporarily stops using the subscription service (example of “stopping provision of the service”) instead of unsubscribing from the subscription service. Furthermore, the “service” may be a service, other than a subscription service, in which the image forming apparatuses 100 is used.

### Processing Flow 1 of Image Forming Apparatus 100

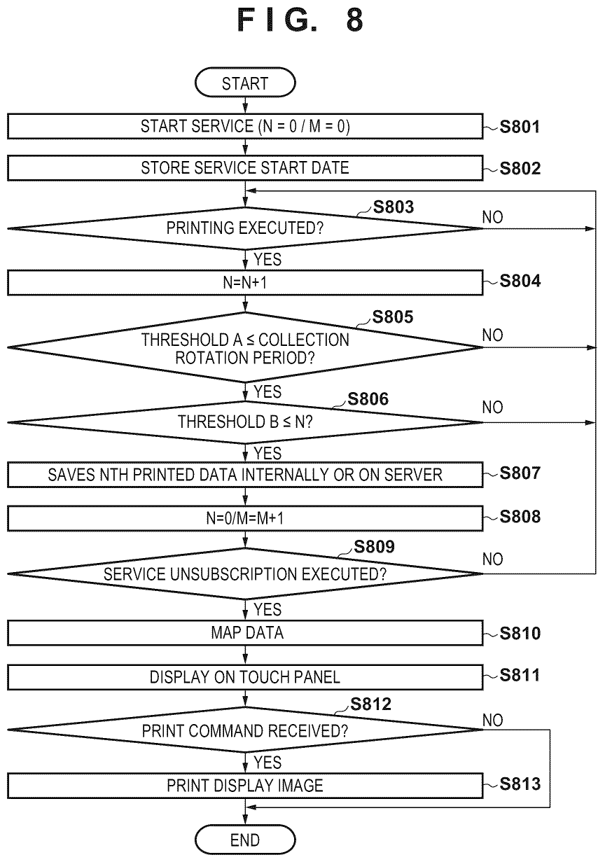

Next, with reference to FIG. 8, an example will be described of a process executed by the image forming apparatus 100 to provide a user notification for expressing gratitude in a case in which the user unsubscribes from the subscription service.

For example, the processing flow described in the following is realized by the CPU 451 of the image forming apparatus 100 loading a program stored in the ROM 452 into the RAM 453 to execute the program. Note that, in the present example, user consent regarding the collection of user data (example of “predetermined condition”) has been obtained in advance. Specifically, the CPU 451 accepts consent from the user via the input-accepting unit 463. Then, the CPU 451 stores user consent information in the NVRAM 454. Note that, for example, the timing when the consent is obtained may be during or after initial setup.

In step S801, the CPU 451 resets a print count counter N and a saved data frame count M that are saved in the NVRAM 454. In step S802, the CPU 451 stores the service start date in the NVRAM 454. In step S803, the CPU 451 determines whether or not printing has been executed. The CPU 451 advances to step S804 if printing has been executed, and otherwise repeats the present determination. In step S804, the CPU 451 increments the print count counter N by 1.

In step S805, the CPU 451 determines whether or not a collection rotation period is more than or equal to a threshold A (example of “predetermined interval”). Note that the collection rotation period is an interval at which printed data (hereinafter “print image”) is saved to the NVRAM 454. Furthermore, the present determination is provided for time-based control of print images that are collected. Note that the threshold A is stored in advance in the NVRAM 454. Furthermore, by the predetermined interval being fixed, data may be periodically saved to the NVRAM 454 in later-described step S807. Alternatively, by the predetermined interval being changed during the subscription to the service, data may be non-periodically saved to the NVRAM 454.

Upon determining that the collection rotation period is more than or equal to the threshold A, the CPU 451 determines whether or not the print count counter N is more than or equal to a threshold B counting from the last time data was saved to the NVRAM 454 in step S806. Note that the threshold B is stored in advance in the NVRAM 454. Furthermore, the print count counter N is an example of the “print count”. Furthermore, the threshold B is an example of the “predetermined number of times”.

Upon determining that the print count counter N is more than to equal to the threshold B in step S806, the CPU 451 saves the Nth printed data internally to the NVRAM 454 (example of “storage unit”) in step S807. Note that the CPU 451 may transmit the Nth printed data to the management server 107 via the communication-controlling unit 455. In such a case, the communication-controlling unit 555 of the management server 107 receives the data, and the data is stored in the RAM 553. Thus, if the RAM 553 has larger capacity than the NVRAM 454, data over a longer period of use can be stored. Note that the Nth printed data is an example of the “data relating to a print image”.

Note that the user may designate the type of data to be stored. Furthermore, the CPU 451 may determine whether or not the type of data that has been printed matches the type designed by the user (example of “predetermined type”), and save the data internally if the data is of the type designated by the user. For example, the CPU 451 may perform control such that print data is saved internally if the print data has the extensions PNG, JPG, and JPEG, and is not saved if the print data has the extensions XLSX, PPTX, and RAW. Such a determination increases the possibility of images captured by the user being saved automatically, and, on the other hand, reduces the possibility of highly confidential documents such as business-related confidential documents being saved automatically.

In step S808, the CPU 451 resets the print count counter N, and increments the saved data frame count M by 1. In step S809, the CPU 451 (example of “first determining unit”) determines whether or not service unsubscription has been executed. Note that, for example, the present determination is executed by the CPU 451 detecting that the subscription service contract information stored in the NVRAM 454 has changed to the unsubscribed state. The CPU 451 advances to step S810 upon determining that service unsubscription has been executed, and otherwise returns the processing to step S803.

In step S810, the CPU 451 generates a display image for expressing gratitude to the user by executing at least one process out of mapping and layout on the M frames of data saved internally in the NVRAM 454. Note that the display image is an example of “first image information based on at least part of the data”. Furthermore, the mapping will be described in detail later. Alternatively, the CPU 451 extracts a character string for expressing gratitude that is saved internally in the NVRAM 454, and maps the extracted character string onto the display image. That is, only print images printed by the user in the past may be provided in the display image. Alternatively, only a character string may be provided in the display image. Alternatively, both print images and a character string may be provided in the display image. Furthermore, in a case in which data has been transmitted to the management server 107 in step S807, the CPU 451 receives the data via the communication-controlling unit 455. Then, the CPU 451 executes at least one process out of the mapping and the layout on the received data.

In step S811, the CPU 451 (example of “outputting unit”) displays, on the touch panel 201 via the displaying unit 459, the display image together with a message inquiring whether or not to print the display image. In step S812, the CPU 451 determines whether or not a print command has been accepted from the user via the input-accepting unit 463. The CPU 451 advances to step S813 if a print command has been accepted, and otherwise terminates the processing in the present flowchart. In step S813, the CPU 451 terminates the processing in the present flowchart after causing the print-controlling unit 456 and the printing unit 457 to print the display image.

### Processing Flow 2 of Image Forming Apparatus 100

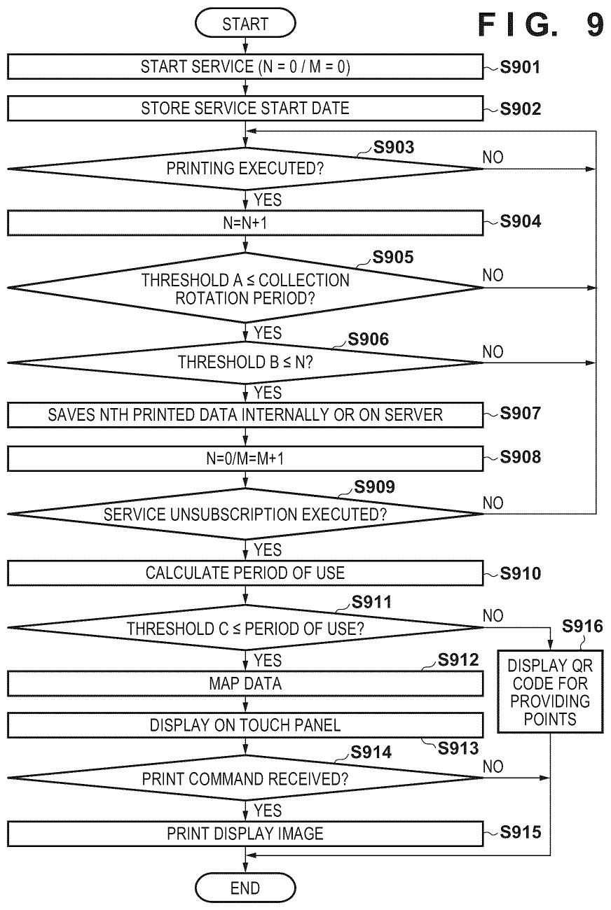

Next, with reference to FIG. 9, another example will be described of a process executed by the image forming apparatus 100 to provide a notification for expressing gratitude when the user unsubscribes. For example, the processing flow described in the following is realized by the CPU 451 of the image forming apparatus 100 loading a program stored in the ROM 452 into the RAM 453 to execute the program. Note that the processing from step S901 to step S909 is the same as the processing from step S801 to step S809 in FIG. 8, and description thereof is thus omitted.

If the CPU 451 determines that service unsubscription has been executed in step S909, the CPU 451 acquires the period of use of the image forming apparatus 100 by the user in step S910 by using the service start date stored in the NVRAM 454 and the current date and time.

In step S911, the CPU 451 (example of “second determining unit”) determines whether or not the period of use is more than or equal to a threshold C (example of “predetermined period”). The CPU 451 advances to step S912 upon determining that the period of use is more than or equal to the threshold C, and otherwise advances to step S916. In step S912, the CPU 451 generates a display image for expressing gratitude to the user by executing at least one of mapping and layout on the M frames of data saved internally in the NVRAM 454. Note that the threshold C is stored in advance in the NVRAM 454.

In step S913, the CPU 451 (example of “outputting unit”) displays, on the touch panel 201 via the displaying unit 459, the display image together with a message inquiring whether or not to print the display image. In step S914, the CPU 451 determines whether or not a print command has been accepted from the user via the input-accepting unit 463. The CPU 451 advances to step S915 if a print command has been accepted, and otherwise terminates the processing in the present flowchart. In step S915, the CPU 451 terminates the processing in the present flowchart after causing the print-controlling unit 456 and the printing unit 457 to print the display image.

On the other hand, in step S916, the CPU 451 terminates the processing in the present flowchart after displaying, on the touch panel 201 via the displaying unit 459, a QR code for providing points to the user together with characters for expressing gratitude. Note that the information displayed on the touch panel 201 may be any information for expressing gratitude to the user, and may be a unique code other than a QR code, or characters or the like for expressing gratitude. In such a case, the user can receive points or a refund by inputting the QR code or the unique code to a specific service website. Note that the CPU 451 may accept a QR code print command from the user via the input-accepting unit 463, and cause the print-controlling unit 456 and the printing unit 457 to print the QR code. Note that the QR code is an example of “second image information relating to the use of a product or service”. Here, the product is a product relating to the image forming apparatus 100, and, for example, is the main body of the image forming apparatus 100 or a consumable used to provide functions of the image forming apparatus 100. Furthermore, the display image displayed on the touch panel 201 in step S916 is an example of the “second image information including character information or code information”.

### Processing Flow of Mapping

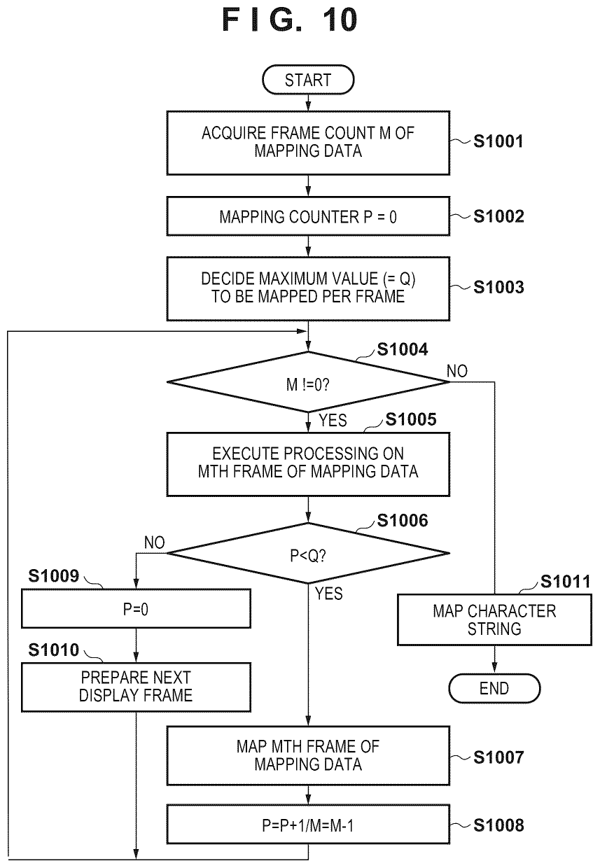

Next, with reference to FIG. 10, the mapping process executed in steps S810 and S912 will be described in detail. For example, the processing flow described in the following is realized by the CPU 451 of the image forming apparatus 100 loading a program stored in the ROM 452 into the RAM 453 to execute the program. Note that the mapping refers to generating a display image by allocating positions for a plurality of pieces of data that have been saved internally in the NVRAM 454 in steps S807 and S907. Alternatively, the mapping refers to generating a display image by newly allocating a position for a character string. Note that gratitude for using the image forming apparatus 100 is expressed to the user by such a display image being displayed on the touch panel 201. Note that the number of display frames may be one, or two or more.

In step S1001, the CPU 451 acquires the frame count M of data (hereinafter “mapping data”) saved in the NVRAM 454 in step S807. In step S1002, the CPU 451 resets the value of a mapping counter P. Note that the mapping counter P indicates the number of times mapping data saved in the NVRAM 454 has been mapped.

In step S1003, the CPU 451 acquires, from the NVRAM 454, the maximum value Q of mapping data to be mapped per one display image frame. Note that the maximum value Q may be defined in advance as a fixed value at the time of shipment from a factory, or may be changed, as appropriate, by the user after shipment from the factory.

In step S1004, the CPU 451 determines whether or not the mapping data frame count M is 0. The CPU 451 advances to step S1011 if the frame count M is 0, and otherwise advances to step S1005.

In step S1005, the CPU 451 executes processing on the Mth frame of mapping data. For example, the processing is enlargement, reduction in size, rotation, or image processing of various types (such as transparency processing, contrast adjustment, or brightness adjustment). The reason for this is because, if mapping data saved in the NVRAM 454 is directly mapped to one display frame, the mapping data may not fit into one display frame depending on the quantity of data.

In step S1006, the CPU 451 (example of “third determining unit”) determines whether or not the mapping counter P has reached the maximum value Q (example of “predetermined value”). Note that the mapping counter P is an example of the quantity of data included in a predetermined frame of first image information. The CPU 451 advances to step S1007 upon determining that the mapping counter P has not reached the maximum value Q, and otherwise advances to step S1009.

In step S1007, the CPU 451 maps the Mth frame of mapping data onto a display frame. In step S1008, the CPU 451 increments the mapping counter P by 1, and decrements the mapping data frame count M by 1. Then, step S1004 is returned to, and the same determination processing is executed.

In step S1009, the CPU 451 resets the mapping counter P to 0. In step S1010, the CPU 451 returns to step S1004 after making preparations such as securing a work area on the NVRAM 454 in order to map mapping data onto the next display frame.

In step S1011, the CPU 451 generates a display image by providing the display frame with a character string for expressing gratitude. Then, the CPU 451 terminates the processing in the present flowchart. Note that the character string to be provided to the display frame is saved in the NVRAM 454. Note that this character string may be any character string for expressing gratitude to the user, and may be defined in advance as a fixed value at the time of shipment from the factory, or may be changed as desired by the user after shipment from the factory.

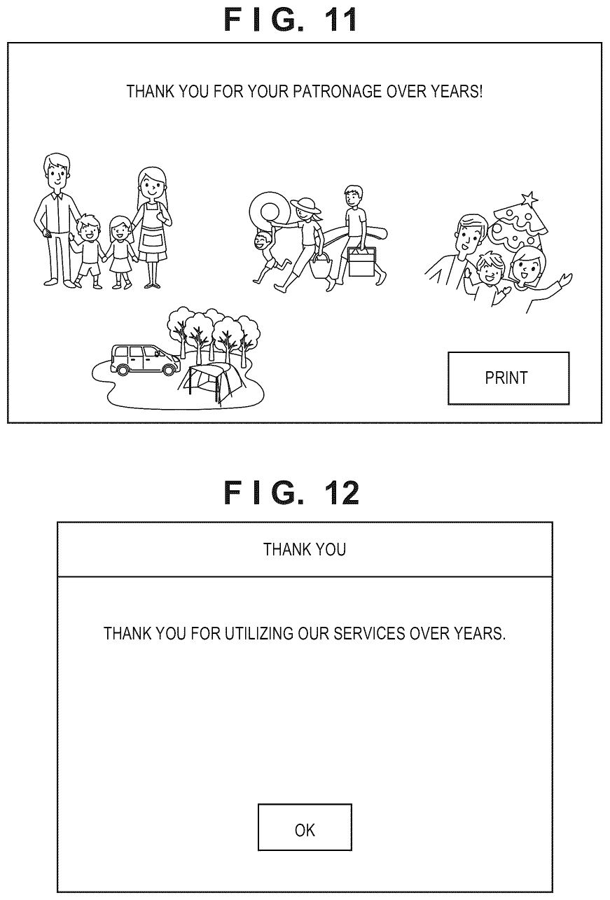

With reference to FIG. 11, an example of a display image displayed on the touch panel 201 in step S811 will be described. For example, in the display image, four pieces of mapping data printed by the user during the period of use of the subscription service are arranged. Furthermore, these pieces of mapping data have been subjected to size reduction processing in step S1005. Furthermore, one piece of mapping data among these pieces of mapping data has been subjected to rotation processing about an axis perpendicular to the page. Furthermore, in the display image, a message for expressing gratitude to the user has been provided in step S1011. Furthermore, a “PRINT” icon is displayed in this display image. When the user operates this icon, the CPU 451 determines in step S914 that a print command has been accepted. Then, in step S915, the CPU 451 prints the display image illustrated in FIG. 11.

FIG. 12 is another example of a display image displayed on the touch panel 201 in step S811. Such a display image is generated in step S1011 if the CPU 451 determines that the mapping data frame count M is 0 in step S1004 in a state in which no mapping data has been mapped onto the display frame. Note that this character string may be a character string randomly selected by the CPU 451 from among character strings saved in the NVRAM 454.

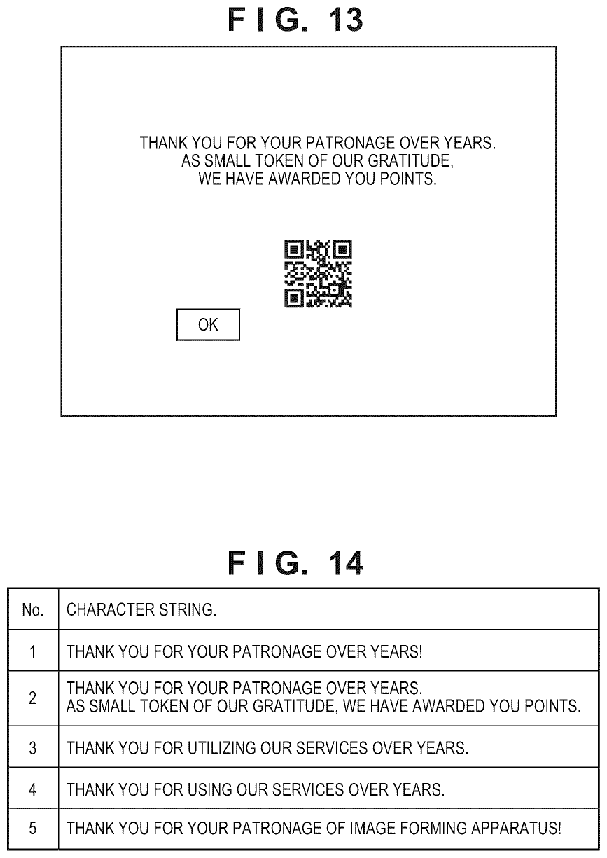

FIG. 13 is an example of a display image displayed on the touch panel 201 in step S916. The image forming apparatus 100 can express gratitude to the user by providing points or money to the user using a QR code. Furthermore, an “OK” icon is displayed in this display image. When the user operates this icon, processing in which this screen transitions to the previous screen is executed. Furthermore, this icon need not be displayed on the display image. In this case, processing for terminating display of the display image after the elapse of a predetermined amount of time may be executed.

FIG. 14 is an example in which character string information saved in the NVRAM 454 is illustrated in the form of a table. For example, in step S1011, the CPU 451 can select the character string to be added to the frame from among such pieces of character string information.

Note that, as the collection-rotation-period threshold A in step S805, a value stored in advance in the NVRAM 454, or a set value set by the user after subscription to the subscription service may be used. The same applies to the period-of-use threshold C in step S911, and the maximum value Q of mapping data to be mapped per one display image frame in step S1003.

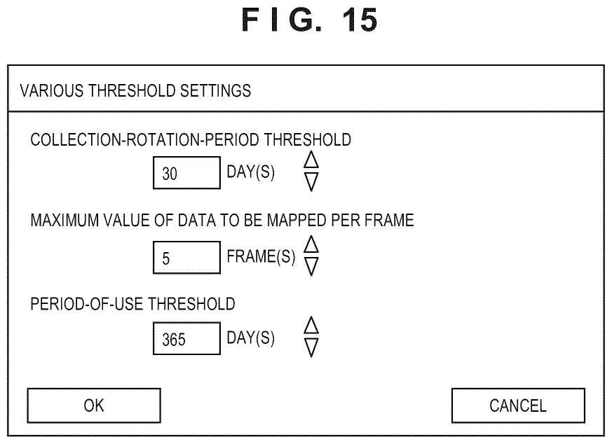

Specifically, for example, the displaying unit 459 displays, on the touch panel 201, a setting screen as illustrated in FIG. 15. Then, when the user operates a region including description of a set value, the input-accepting unit 463 accepts setting information. Then, the CPU 451 stores such setting information in the NVRAM 454.

### Operation and Effect

According to the above-described image forming apparatus 100, in a case in which the user unsubscribing from the subscription service is a heavy user, gratitude can be expressed to the user by a display image as illustrated in FIG. 11 being displayed. Thus, customer satisfaction is improved. Furthermore, according to the image forming apparatus 100, printed data is stored in the NVRAM 454 if the collection rotation period is more than or equal to the threshold A. Accordingly, mapping data included in the display image can be prevented from being biased to data corresponding to a short period of time. Accordingly, the user can be reminded of memories from over a long period of time. Thus, it is possible to have the user feel a sense of attachment to the image forming apparatus 100. Thus, the probability increases of the user using a product or service of the manufacturer of the image forming apparatus 100 again.

Furthermore, even if the period of use of the image forming apparatus 100 is short, gratitude can be expressed to the user by a display image as illustrated in FIG. 13 being displayed. Thus, customer satisfaction is improved for such a user as well. Thus, the probability increases of a product or service of the manufacturer of the image forming apparatus 100 being used again. Furthermore, according to the image forming apparatus 100, the number of pieces of mapping data included in the display image can be limited. Thus, for example, if one or more face images are included in the mapping data, face images shown on the touch panel 201 would be easily visible. Furthermore, according to the image forming apparatus 100, the threshold A, the threshold C, and the maximum value Q can be set as illustrated in FIG. 15. Thus, a display image as desired by the user can be generated. Thus, user customer satisfaction is improved. Thus, the probability increases of a product or service of the manufacturer of the image forming apparatus 100 being used again.

### Modifications

The present disclosure is not limited to the above-described embodiment, and various modifications may be made thereto. For example, the present disclosure may be configured such that, in steps S811, S913, and S916, the CPU 451 transmits display image information to an apparatus external to the image forming apparatus 100 via the communication-controlling unit 455 and causes the external apparatus to display the display image. Note that, for example, the external apparatus is the host terminal 101 owned by the user, and the display image information may be transmitted to the host terminal 101 using the Bluetooth standard. This is an example of the “communicating unit transmitting data to outside the image forming apparatus”.

Furthermore, in step S914, the CPU 451 may receive a print command from the management server 107 via the communication-controlling unit 455.

Furthermore, in step S807, if highly confidential information such as business-related information is included in data printed by the user in the past, the CPU 451 may process the data using a method for smoothing pixel values, such as the pixel averaging method or the image median method. Here, the determination of whether or not highly confidential information is included in data is executed by determining whether or not the character for “secret” or “confidential” or information such as an address is included in the data. Furthermore, the CPU 451 may store the smoothed data in the NVRAM 454. According to such an image forming apparatus 100, the leakage of confidential information can be prevented. Note that another example of highly confidential information is personal information descriptive of the user (e.g., the year, month, and date of birth), etc.

Furthermore, a configuration may be adopted such that, in step S807, if personal information (e.g., face information or the like) is not included in data printed by the user in past, the CPU 451 does not store the data in the NVRAM 454. According to such an image forming apparatus 100, personal information would be automatically included in the display image. Thus, the user would be reminded of memories strongly upon viewing the display image. User customer satisfaction would be improved in such a case. Thus, the probability increases of a product or service of the manufacturer of the image forming apparatus 100 being used again.

Furthermore, in step S807, the CPU 451 may store data printed by the user in the past in the NVRAM 454 together with data of the date when the data was printed. According to such an image forming apparatus 100, dates would be included in the display image. Thus, the user would be reminded of memories more strongly upon viewing the display image. Accordingly, user customer satisfaction is improved. Thus, the probability increases of a product or service of the manufacturer of the image forming apparatus 100 being used again. Furthermore, the present disclosure is not limited to print data and/or a character string printed in the past by the user being displayed on the display image in step S810. For example, one or more characters that do not form a character string, one or more figures, one or more codes, etc., may be displayed.

Furthermore, the maximum value Q used for the determination processing in step S1006 may be changed for each display frame. Furthermore, part of or all of the data stored in the NVRAM 454 may be used in the display image. Furthermore, in the processing flow of the image forming apparatus 100 illustrated in FIG. 8, at least one determination process among those in steps S803, S805, and S806 may be omitted.

Furthermore, in a case in which the user changes the pricing plan for use of the image forming apparatus 100, display images as illustrated in FIG. 11 to FIG. 13 may be displayed by the above-described processing flows being executed. Furthermore, display images as illustrated in FIG. 11 to FIG. 13 may be displayed in a case in which the image forming apparatus 100 is replaced with another. Furthermore, display images as illustrated in FIG. 11 to FIG. 13 may be displayed in a case in which a consumable produced by a group company of the manufacturer of the image forming apparatus 100 is newly purchased. These are examples of the “product or subscription service relating to the image forming apparatus”. User customer satisfaction would be improved in such cases.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-093202, filed Jun. 7, 2024, which is hereby incorporated by reference herein in its entirety.

What is claimed is:

1. An image forming apparatus included in an image forming system, the image forming apparatus comprising:
one or more memory devices that store a set of instructions; and
one or more processors that execute the set of instructions to:
store data relating to a print image printed during use of a subscription service relating to the image forming apparatus;
determine whether or not input for stopping the use of the subscription service has been accepted; and
output an image based on at least part of the data upon determining that the input has been accepted.

2. The image forming apparatus according to claim 1,
wherein the one or more processors execute instructions in the one or more memory devices to:
store the data each time a predetermined interval elapses during the use of the subscription service.

3. The image forming apparatus according to claim 2,
wherein the one or more processors further execute instructions in the one or more memory devices to:
determine whether or not a period of use of the subscription service has equaled or exceeded a predetermined period;
output the image upon determining that the period has equaled or exceeded the predetermined period; and
output another image relating to the use of the subscription service upon determining that the period has not reached the predetermined period.

4. The image forming apparatus according to claim 3,
wherein the one or more processors further execute instructions in the one or more memory devices to:
determine whether or not a quantity of predetermined data among the stored data has reached a predetermined value; and
output the predetermined data as the image in a state in which the predetermined data is included in a predetermined frame upon determining that the quantity has not reached the predetermined value.

5. The image forming apparatus according to claim 4,
wherein the predetermined interval, the predetermined period, and the predetermined value can be configured.

6. The image forming apparatus according to claim 3,
wherein the other image includes a character or a code.

7. The image forming apparatus according to claim 1,
wherein the one or more processors execute instructions in the one or more memory devices to:
store next data if a print count of the print image exceeds a predetermined number of times after the data is stored.

8. The image forming apparatus according to claim 1,
wherein the one or more processors execute instructions in the one or more memory devices to:
not store the data if the print image does not include personal information.

9. The image forming apparatus according to claim 1,
wherein the one or more processors execute instructions in the one or more memory devices to:
store the data obtained by smoothing out pixel values of pixels constituting the print image including highly confidential information.

10. The image forming apparatus according to claim 1,
wherein the one or more processors execute instructions in the one or more memory devices to:
store the data if the print image is of a predetermined type.

11. The image forming apparatus according to claim 1,
wherein the data includes a date when the print image was printed.

12. The image forming apparatus according to claim 1,
wherein the one or more processors further execute instructions in the one or more memory devices to:
accept consent of a user to store the print image under a predetermined condition; and
store the data if the predetermined condition is satisfied.

13. The image forming apparatus according to claim 1,
wherein the data is stored in an internal storage unit.

14. The image forming apparatus according to claim 1,
wherein the one or more processors further execute instructions in the one or more memory devices to:
communicate with an external computer.

15. The image forming apparatus according to claim 14,
wherein the one or more processors execute instructions in the one or more memory devices to:
transmit the image to outside the image forming apparatus.

16. The image forming apparatus according to claim 14,
wherein the one or more processors execute instructions in the one or more memory devices to:
transmit the data to outside the image forming apparatus.

17. A method for controlling an image forming apparatus included in an image forming system, the method comprising:
storing data relating to a print image printed during use of a subscription service relating to the image forming apparatus;
determining whether or not input for stopping the use of the subscription service has been accepted; and
outputting an image based on at least part of the data if it is determined in the determining that the input has been accepted.

18. A non-transitory computer-readable storage medium storing a computer program that causes a computer to execute a method for controlling an image forming apparatus included in an image forming system, the method comprising:
storing data relating to a print image printed during use of a subscription service relating to the image forming apparatus;
determining whether or not input for stopping the use of the subscription service has been accepted; and
outputting an image based on at least part of the data if it is determined in the determining that the input has been accepted.
